(19) United States
(12) Patent Application Publication
(10) Pub. No.: US 2011/0183232 A1
(43) Pub. Date: Jul. 28, 2011

(54) STRUCTURES FOR GAS DIFFUSION ELECTRODES

(75) Inventors: Yu-Min Tsou, Princeton, NJ (US); Zhlyong Zhu, Middlesex, NJ (US); Daniel Rosa, Staten Island, NY (US); Emory Do Castro, Nahant, MA (US)

(73) Assignee: BASF Fuel Cell Gmbh, Frankfurt Am Main (DE)

(21) Appl. No.: 12/442,546

(22) PCT Filed: Sep. 25, 2007
(86) PCT No.: PCT/EP2007/008298

§ 371 Date: Mar. 8, 2010

Related U.S. Application Data
(60) Provisional application No. 60/827,315, filed on Sep. 28, 2006.

(30) Foreign Application Priority Data
Sep. 28, 2006 (EP) 06020369.2

(51) Int. Cl. H01M 8/10; H01M 4/86; H01M 4/96; H01M 4/92

(52) U.S. Cl. 429/481; 429/523; 429/534; 429/524; 429/527

(57) ABSTRACT

A gas diffusion electrode comprises at least one gas diffusion media, at least one supported catalyst layer disposed on top of the gas diffusion media, the supported catalyst layer comprising at least one supported catalyst, and an unsupported catalyst layer disposed on top of the supported catalyst layer, the unsupported catalyst layer having a higher total catalyst loading than the supported catalyst layer.

### PRIORITY

This application is a national stage application (under 35 U.S.C. §371) of PCT/EP2007/008298, filed Sep. 25, 2007, which claims benefit of European application 06020369.2, filed Sep. 28, 2006 and U.S. Provisional application 60/827,315, filed Sep. 28, 2006.

### BACKGROUND OF THE INVENTION

The invention relates to gas diffusion electrode architecture and gas diffusion electrode backings for electrochemical applications, and to methods for producing the same.

Gas diffusion electrodes are increasingly used in electrochemical applications such as fuel cells and electrolysers, particularly in those applications making use of ion-exchange membranes as separators and/or as electrolytes. A gas diffusion electrode (also called “GDE”) is normally comprised of a web, acting as a support, coating layers applied on one or both sides thereof which is also referred to as gas diffusion media (also called “GDM”) and a catalyst on top of the GDM. The coating layers have several functions, the most important of which are providing channels for water and gas transport and conducting electric current. Coating layers, especially the outermost ones, may also have additional functions such as catalysing an electrochemical reaction and/or providing ionic conduction, particularly when they are used in direct contact with an ion-exchange membrane. For most applications it is desirable to have a porous current conducting web (such as a carbon cloth, a carbon paper or a metal mesh) coated with current conducting layers. It is also desirable that the channels for water and for gas transport to be separate channels, characterized by different hydrophobicity and porosity.

It is known in the art that GDM may be advantageously provided with two different layers, an inner and an outer coating layer, having different characteristics: for instance, U.S. Pat. No. 6,017,650 discloses the use of highly hydrophobic GDM coated with more hydrophilic catalytic layers for use in membrane fuel cells.

U.S. Pat. No. 6,103,077 discloses methods for automatically manufacturing such type of gas diffusion electrodes (GDE) and electrode backings with industrial coating machines. In the cited documents, the coating layers are composed by mixtures of carbon particles and a hydrophobic binder such as PTFE, and the methods of obtaining a diffusive and a catalytic layer with distinct characteristics comprise the use of different relative amounts of carbon and binder materials and/or the use of two different types of carbon in the two layers.

Moreover, GDM having two layers with different porosity are known in the art: DE 198 40 517' for instance, discloses a bi-layer structure consisting of two sub-structures with different porosity. Surprisingly, the layer with higher porosity and gas permeability is the one in contact with the membrane, while the less porous and permeable layer is the one that contacts the web. There is in fact a general understanding that a desirable porosity gradient should provide a less permeable structure for the layer in contact with the membrane, for example as disclosed for the catalytic layer of WO 00/38261. Although in such case the porosity gradient is not obtained in a GDM but only in a very thin catalytic hydrophilic layer in direct contact with an ion-exchange membrane, the general teaching that a less porous property is desirable for the side of a gas-fed electrode structure which has to be coupled to a membrane electrolyte may be regarded as a common knowledge in the art.

Such type of bi-layer gas diffusion structures show adequate performances in most applications; however, there are a few critical applications in which the gas diffuser architecture of the prior art does not meet the gas and water transport requirements to a sufficient extent.

Particularly critical applications comprise, for instance, membrane fuel cells operating at relatively high temperature (close to or higher than 100° C.) and oxygen-depolarized aqueous hydrochloric acid electrolysers, especially if operating at high current density or if depolarized with air or other depleted oxygen-containing mixtures instead of pure oxygen. In these cases, the optimum gas/liquid transport and water management are not achieved by means of a simple bi-layer gas diffusion structure.

The aforementioned and other problems of the prior art gas diffusion electrode architectures become even more severe when such GDE are used in direct methanol fuel cells (also called “DMFC”).

In a DMFC, the function of the GDE, e.g. as anode, is to allow methanol to be electrochemically oxidized at a high rate and in the meantime to minimize the cross-over of the methanol to the cathode side. Cross-over of the methanol to the cathode side leads to the occurrence of both methanol oxidation and oxygen reduction on the cathode surface. It results in “short-circuit” of the intended electrochemical reaction and leads to converting useful electric energy to wasteful heat. Another problem in DMFC is that that the GDE, e.g. as cathode, is flooded due to methanol cross-over. This flooding can also become more severe by accumulation of water in the cathode. Such flooding with water and/or methanol impedes the diffusion of oxygen through the GDE and results in a loss of performance of the GDE.

GDE for DMFC are known and can be divided into two categories:
(1) catalyst-coated membrane type (CCM); in which an anode catalyst decal is formed on a PTFE sheet, the decal is transferred by a hot pressing process to a membrane. (see S. C. Thomas, X. Ren, S. Gottesfeld, J. Electrochem. Soc., 146, 4354 (1999) and M. S. Wilson and S. Gottefeld, J. Electrochem. Soc., 139, 28 (1992) and
(2) Catalyzed Gas, in which catalyst layer is applied to a pre-fabricated gas diffusion layer or media (see B. Gurau, E. S., Smotkin, J. Power Sources 112, 339 (2002).

### SUMMARY OF THE INVENTION

The present invention has the object of providing an improved gas diffusion electrode architecture, in particular for DMFC, which permits to overcome the limitations and drawbacks of the prior art and an electrochemical cell making use of the same.

The aforementioned and further objects which have not been explicitly mentioned but can be readily derived and concluded from the prior art discussed above can be achieved by a gas diffusion electrode (GDE) comprising:
a) at least one gas diffusion media (GDM),
b) at least one catalyst layer on top of said gas diffusion media comprising at least one supported catalyst and
c) at least one unsupported catalyst layer on top of the supported catalyst layer mentioned under b) above, said unsupported catalyst layer having a higher total catalyst loading than in b).

The GDE according to the invention can be used in fuel cells, in particular ion exchange membrane fuel cells, as oxygen-depolarized aqueous hydrochloric acid electrolysers, especially if operating at high current density or if depolarized with air or other depleted oxygen-containing mixtures instead of pure oxygen, and in battery systems or sensor systems.

Gas diffusion media (GDM) are known per se, e.g. U.S. Pat. No. 6,017,650, U.S. Pat. No. 6,379,834 and U.S. Pat. No. 6,165,636. These and other aspects will become apparent to those skilled in the art in view of the following description, whose only purpose is to illustrate representative embodiments of the invention without constituting a limitation of the same.

### DETAILED DESCRIPTION OF THE PREFERRED EMBODIMENTS

As mentioned above, the gas diffusion media of the prior art have always been pictured as a dual structure performing two separate functions in two distinct regions: an active region towards the catalyst which is in contact with the ion exchange membrane, in particular proton conductive membranes, directed mainly to facilitating a three-phase reaction on the catalyst particles, requiring an extended interface provided with ionic and electronic conduction and therefore a remarkable hydrophilic character, and a region directed mainly to gas diffusion and provided with a strong hydrophobic character to facilitate the transport of gas through its pores.

Furthermore, in order to exploit the full properties of the present invention, a porosity fine gradient shall also be established across the whole gas diffusion structure, with larger pores on the coating layers in direct contact with the supporting web and smaller pores on the opposite surface towards the catalyst.

In an alternative embodiment, the gas diffusion media is comprised of a non catalyzed portion having fine porosity and hydrophobicity gradients in the direction of its thickness, and of a superposed catalyzed portion preferably having distinct porosity and hydrophobicity fine gradients in the direction of its thickness.

Most preferred GDM comprise a multilayer coating on a web, the coating being provided with fine gradients of porosity and hydrophobicity across the whole thickness. By fine gradient it is intended a monotonous and substantially regular variation of the relevant parameter. Such GDM are disclosed in the U.S. Patent Application 2005/0106451 which is incorporated as reference.

Typically, in a preferred embodiment, the GDM is provided with a coating comprising carbon and binder particles. Carbon particles are essentially used to provide electric conductivity; it is understood that other types of electrically conductive particles, for instance metal particles, may be used instead of the carbon particles or in addition.

Binders are used to impart structural properties to the coating, and may be also advantageously used to vary the hydrophobic/hydrophilic properties of the coating. Polymeric binders are preferred for this application, especially partially fluorinated or perfluorinated binders such as PTFE (capable of imparting a hydrophobic character) or sulphonated perfluorocarbonic acids such as Nafion® (capable of imparting a hydrophilic character). In one preferred embodiment, the hydrophobicity and porosity fine gradients are simultaneously achieved by providing a multilayer coating in which the weight ratio of carbon to binder particles is systematically varied; a GDM may thus consist of a variable number of individual coats, typically from 3 to 8. The higher is the number of coatings, the better is the resulting GDM in terms of fine gradient structure. However, the number of coatings must be limited for practical reasons, and more importantly to maintain the required characteristics of gas permeability.

In another preferred embodiment, the hydrophobicity and porosity fine gradients are simultaneously achieved by providing a multilayer coating in which the weight ratio between two different types of carbon, a more hydrophobic carbon such as graphite or acetylene black and a more hydrophilic carbon such as a carbon black is systematically varied. In another preferred embodiment, both the weight ratio between two different types of carbon and the weight ratio of carbon to binder particles are systematically varied. In another preferred embodiment, the hydrophobicity and porosity fine gradients are simultaneously achieved by providing a multilayer coating in which the weight ratio between two different types of binder, a hydrophobic carbon such as PTFE and a hydrophilic binder such as Nafion® is systematically varied. All of these different techniques to achieve simultaneous hydrophobicity and porosity fine gradients may be combined in several ways.

In a preferred embodiment of the GDM, the weight ratio of hydrophobic binder to carbon in each layer is comprised between 0.1 and 2.3; when two different types of carbon are used, the weight ratio between said two types of carbon is typically in the range of 1:9 and 9:1. However, more than two types of carbon may be used in the construction of the GDM to achieve the required hydrophobicity and porosity fine gradients.

The supporting substrates used for the GDM are generally electron conductive. Flat, electrically conductive, acid-resistant configurations are usually used for this purpose. These include, for example, carbon fibre papers, graphitised carbon fibre papers, carbon fibre fabric, graphitised carbon fibre fabric and/or sheets which have been rendered conductive by the addition of carbon black.

In a preferred embodiment more that one, in particular from two to five, more preferred two or three GDMs are present in the GDE according to the instant invention.

In a GDM, the ratio of the weight of the coating to the supporting substrate is usually in the range of about 0.1 to 0.8, and preferably in the range about 0.2 to 0.6. The carbon used is usually carbon black, such as SAB or Vulcan®.

The GDE according to the instant invention contains catalysts. These include, inter alia, precious metals, in particular platinum, palladium, rhodium, iridium, osmium and/or ruthenium. These substances may also be used in the form of alloys with one another.

Furthermore, these substances may also be used in an alloy with non-precious metals, such as for example Fe, Cr, Zr, Ni, Co, Mn, V and/or Ti. In addition, the oxides of the aforementioned precious metals and/or non-precious metals may be used.

In case the GDE according to the invention will be used as anode in a membrane-electrode assembly for making direct methanol, hydrogen/air, or reformate/air fuel cells, it is preferred that the catalysts typically comprises at least platinum and ruthenium.

In case the GDE according to the invention will be used as cathode in a membrane-electrode assembly for making direct methanol, hydrogen/air, or reformate/air fuel cells, it is preferred that the catalysts typically comprises platinum, platinum iridium, or platinum rhodium alloy.

Furthermore, the catalytically active layer may contain conventional additives. These include inter alpha-fluorine polymers such as polytetrafluoroethylene (PTFE) and surface-active substances.

Surface-active substances include in particular ionic surfactants, for example fatty acid salts, in particular sodium laurate, potassium oleate; and alkylsulphonic acids, alkylsulphonic acid salts, in particular sodium perfluorohexanesulphonate, lithium perfluorohexanesulphonate, ammonium perfluorohexanesulphonate, perfluorohexanesulphonic acid, potassium nonafluorobutanesulphonate, and nonionic surfactants, in particular ethoxylated fatty alcohols and polyethyleneglycols.

Particularly preferred additives include fluorine polymers, in particular tetrafluoroethylene polymers. According to a particular embodiment of the present invention, the ratio by weight of fluorine polymer to catalyst material, comprising at least one precious metal and optionally one or more support materials is greater than about 0.05, this ratio preferably being in the range of about 0.15 to 0.7.

According to a particular embodiment of the present invention, the catalyst layer has an overall thickness in the range of about 1 to 1000 μm, in particular of 5 to 200, preferably of 10 to 100 μm. This value represents an average value which may be determined by measuring the layer thickness in the cross section of photographs obtained using a scanning electron microscope (SEM).

According to a particular embodiment of the present invention, the overall precious metal content of the catalyst layer is about 0.1 to 10.0 mg/cm², preferably about 1 to 8.0 mg/cm² and particularly preferably about 2 to 6 mg/cm². These values may be determined by elemental analysis of a flat sample.

According to the invention, the catalyst layer may be applied by a process in which a catalyst suspension is used. In addition, catalyst-containing powders may also be used. The catalyst suspension contains a catalytically active substance. These substances have previously been described in more detail in conjunction with the catalytically active layer.

Furthermore, the catalyst suspension may contain conventional additives. These include inter alia fluorine polymers such as polytetrafluoroethylene (PTFE), thickeners, in particular water-soluble polymers such as cellulose derivatives, polyvinyl alcohol, polyethyleneglycol, polyethylene, poly(ethylene oxide) and surface-active substances, which have previously been described in more detail in conjunction with the catalytically active layer.

The surface active substances include, in particular, ionic surfactants, for example fatty acid salts, in particular sodium laurate, potassium oleate; and alkylsulphonic acids, alkylsulphonic acid salts, in particular sodium perfluorohexanesulphonate, lithium perfluorohexanesulphonate, ammonium perfluorohexanesulphonate, perfluorohexanesulphonic acid, potassium nonafluorbutanesulphonate, and nonionic surfactants, in particular ethoxylated fatty alcohols and polyethyleneglycols or fluorosurfactant such as DuPont Zonyl FSO® surfactant.

Furthermore, the catalyst suspension may comprise constituents that are liquid at ambient temperature. These include inter alia organic solvents, which may be polar or non-polar, phosphoric acid, polyphosphoric acid and/or water. The catalyst suspension preferably contains 1 to 99% by weight, in particular 10 to 80% by weight, of liquid constituents.

The polar organic solvents include, in particular, alcohols, such as methanol, ethanol, propanol, isopropanol and/or butanol.

The organic non-polar solvents include inter alia known thin-film evaporators, such as thin-film evaporator 8470 made by DuPont, which comprises turpentine oils.

Particularly preferred additives include fluorine polymers, in particular tetrafluoroethylene polymers. According to a particular embodiment of the present invention, the ratio by weight of fluorine polymer to catalyst material, comprising at least one precious metal and optionally one or more support materials is greater than about 0.15, preferably being in the range of about 0.15 to 0.7.

The formation of the catalyst layers and/or the deposition of the catalyst particles can be done by the methods known to the skilled worker.

The GDE according to the instant invention comprises at least one catalyst layer on top of said gas diffusion media towards the membrane comprising at least one supported catalyst. Preferred supports are carbon, in particular, in the form of carbon black, graphite or graphitized carbon black. The metal content of these supported particles, based on the total weight of the particles, is generally in the range of about 10% to 90% by weight, preferably about 20% to 80% by weight and particularly preferably about 40 to 80% by weight, without being limited thereto. The particle size of the support, in particular the size of the carbon particles, is preferably in the range of about 20 to 100 nm, in particular about 30 to 60 nm. The size of the metal particles located thereon is preferably in the range of about 1 to 20 nm, in particular about 1 to 10 nm and particularly preferably about 2 to 6 nm.

In a preferred embodiment of the invention, the GDE according to the instant invention comprises at least two catalyst layers on top of said gas diffusion media towards the membrane each layer comprising at least one supported catalyst having a different metal content. Different metal content means, that the first supported catalysts layer on top of the GDM has a lower metal content than the next supported catalyst layer. In such an at least bi-layered structure, generally metal contents of the first supported catalyst layer are from about 1 to 80% by weight, preferably about 20 to 80% by weight, particularly preferably about 40 to 80% by weight and most preferred about 40 to 70% by weight, while the preferred metal contents of the subsequent supported catalyst layer, which contains catalyst layer with higher loading than the first supported catalyst layer, are from about 10 to 99% by weight, preferably about 30 to 95% by weight and particularly preferably about 50 to 90% by weight. By such different metal content a gradient can be established to satisfy special requirements.

Preferred catalyst metals for the supported catalyst are Pt, Pd, Ir, Rh, Os and/or Ru. Beside the aforementioned metals the metals Au and/or Ag can be present. In addition, the aforementioned metal catalysts can also be used in the form of alloys comprising (i) Pt, Pd, Ir, Rh, Os or Ru and (ii) Fe, Co, Ni, Cr, Mn, Zr, Ti, Ga or V.

The sizes of the various particles represent average values of the weight average and may be determined by transmission electron microscopy.

The above-described catalytically active particles are generally commercially available, such as those supplied by E-TEK PEMEAS USA Inc. E-TEK® Division.

The GDE according to the instant invention comprises at least one unsupported catalyst layer on top of the supported catalyst towards the membrane, preferably an unsupported black precious metal catalyst.

The catalytically active particles, which comprise the aforementioned substances, may be used as powdered metal, and are also known as black precious metal, in particular platinum and/or platinum alloys. Particles of this type generally have a size in the range of about 3 nm to 200 nm, preferably in the range of about 4 nm to 12 nm, and most preferably in the range of about 4 nm to 7 nm.

The GDE according to the instant invention has a at least one catalyst layer on top of a gas diffusion media, said catalyst layer comprises at least one supported catalyst. On top of the aforementioned catalyst layer, the GDE has a further catalyst layer which comprises at least one unsupported catalyst layer. The total metal content of the unsupported catalyst layer is higher that the total catalyst content of the catalyst layer comprising the supported catalyst.

Preferred unsupported black precious metal catalysts are are Pt, Pd, Ir, Rh, Os and/or Ru. Beside the aforementioned metals the metals Au and/or Ag can be present. In addition, the aforementioned metal catalysts can also be used in the form of alloys comprising (i) Pt, Pd, Ir, Rh, Os or Ru and (ii) Fe, Co, Ni, Cr, Mn, Zr, Ti, Ga or V. Most preferred are Pt or PtRu metal catalysts.

Most preferred are GDE having at least one catalyst layer on top of a gas diffusion media, said catalyst layer comprises at least one supported catalyst having up to 80% by weight of Pt on a carbon support. On top of the aforementioned catalyst layer, the GDE has a further catalyst layer which comprises at least one unsupported catalyst layer consisting of 100% by weight Pt. The total metal content of the unsupported catalyst layer is higher that the total catalyst content of the catalyst layer comprising the supported catalyst.

The sizes of the various particles represent average values of the weight average and may be determined by transmission electron microscopy.

The above-described black catalysts are generally commercially available from PEMEAS USA, E-TEK.

In a preferred embodiment of the invention, the GDE according to the instant invention comprises at least two catalyst layers on top of the GDM, the layer close to GDM comprises supported catalyst and the layer close to the membrane comprises unsupported (black) catalyst.
Preferred metal contents of the supported catalyst is generally from 10% to 95% Pt by weight, preferably 20 to 90% Pt by weight and particularly preferably 60 to 80% Pt by weight.

A membrane electrode unit may also be produced using the GDE according to the instant invention. Such membrane electrode unit is typically manufactured by hot pressing. For this purpose, the GDE and a membrane, typically an ion exchange membrane, in particular a proton conductive membrane is heated to a temperature in the range of about 50° C. to 200° C. and pressed at a pressure of about 1 to 10 MPa. A few minutes are generally sufficient to join the catalyst layer to the membrane. This time is preferably in the range of about 30 second to 10 minutes, in particular about 30 seconds to 5 minute.

In a further embodiment, the membrane electrode unit can be obtained by applying a catalyst layer on the membrane first to make catalyst-coated membrane (CCM) first and then the CCM is laminated with a GDM on a substrate. The applied catalyst layer has the multiple-layer structure as described above: either with two supported catalyst layers (and the supported catalyst with higher loading is adjacent to the membrane); or with a black catalyst layer-supported layer structure and the black catalyst layer is adjacent to the membrane. The membrane may be provided with a multi-layer catalyst layer on one or both sides. If the membrane is provided with a catalyst layer only on one side, the opposite side of the membrane has to be pressed with an electrode comprising a catalyst layer. If both sides of the membrane are to be provided with a catalyst layer, the methods may also be combined to achieve an optimum result.

A process for producing commercial volumes of such membrane electrode units is disclosed in EP-A-868760 corresponding to U.S. Pat. No. 6,197,147 which is hereby incorporated by reference.

Hence, the present invention also relates to membrane electrode unit comprising at least one GDE according to the invention.

A further embodiment of the instant invention is directed to a GDE which is used as cathode in a membrane-electrode assembly for making direct methanol fuel cells. In such embodiment, the GDE according to the instant invention comprises ionomers in the supported catalyst layer, preferably in both the supported catalyst layer(s) and the black catalyst layer(s). Suitable ionomers are perfluorosulfonated type commonly used in fuel cell stacks and marketed by E. I. Pont, Asahi Kasei, Asahi Glass, Golden Fuel Cell Energy, etc. Other ionic polymer can also be used, e.g., polyelectrolyte containing phosphate, sulfate, if they are stable under operating condition. The catalyst to ionomer weight ration is generally in the range of 95:5 to 5:95, preferably in the range of 95:5 to 40:60, and most preferably in the range of 90:10 to 60:40.

A further embodiment of the instant invention is directed to a GDE which is used as anode in a membrane-electrode assembly for making direct methanol fuel cells. In such embodiment, the parameters and information associated with ionomers are as described above for the cathode.

The invention will be further explained by resorting to a few examples, which are not intended as a limitation of the scope thereof.

When the word “about” is used herein it is meant that the amount or condition it modifies can vary some beyond that stated so long as the advantages of the invention are realized. Practically, there is rarely the time or resources available to very precisely determine the limits of all the parameters of one's invention because to do so would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors' disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without any unexpected characteristics, those embodiments are within the meaning of the term “about” as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### EXAMPLES

### Preparation of Gas Diffusion Media

A gas diffusion media (GDM) was made on a commercial carbon cloth by applying several layers of ink consisting of carbon and Teflon® (E. I. du Pont, Wilmington, Del., USA) followed by sintering at 300-350° C. Carbon paper can be used in place of the cloth.

### Example 1

The GDM was then applied with an ink prepared by mixing 80% PtRu on Ketjen Carbon Black (available from PEMEAS USA Inc. E-TEK® Division)—which was synthesized as described in U.S. Patent application (Appl. 20060014637), perfluorocarbon ion exchange ionomer, and an ethanol/water mixture as solvent is applied. The ink was applied with a film applicator to the GDM followed by drying at 70-95° C.

Multiple layers are applied until a loading of 3 mg/cm² of total metal is achieved. In the next step an ink prepared by mixing PtRu black catalyst (available from PEMEAS USA Inc. E-TEK® Division), which was synthesized as described in U.S. Patent application (Appl. 20060014637), perfluorocarbon ion exchange ionomer, a surface active agent (Zonyl FSO® surfactant by E.I. du Pont) and an ethanol/water mixture as solvent is applied. The ink was then applied on top of the 80% PtRu catalyst layer to a total metal loading of 2 mg/cm². Overall in this bi-layer anode, there were 5 mg/cm² total metal. After all layers were applied, a final drying at 70-95° C. for at least 30 min was conducted.

### Example 2

### Comparative Example

The GDM was applied with the PtRu black ink as described in Example 1. The same drying process as in Example 1 was used. The final total metal loading was 5 mg/cm².

### Example 3

### Comparative Example

The GDM was applied with an ink containing 80% PtRu on Ketjen Carbon Black as described in Example 1. The same drying process as in Example 1 was used. The total metal loading was 4 mg/cm².

### Membrane Electrode Assembly (MEA) Fabrication

### Example 4

The electrodes prepared in Example 1 was put on one side of a Du Pont Nafion 117 (7 mil thickness and 1100 equivalent weigh) membrane (from E. I. du Pont, Wilmington, Del., USA) as anode and an E-TEK standard DMFC cathode, which has 4.5 mg/cm² Pt, was put on the other side of the membrane. The assembly was pressed at 130° C. at a pressure about 50-100 atm for 3-5 min.

### Example 5

The electrodes prepared in Example 2 was put on one side of a Du Pont Nafion 117 (7 mil thickness and 1100 equivalent weigh) membrane (from E. I. du Pont, Wilmington, Del., USA) as anode and an E-TEK standard DMFC cathode, which has 4.5 mg/cm² Pt, was put on the other side of the membrane. The assembly was pressed at 130° C. at a pressure about 50-100 atm for 3-5 min.

### Examples 6

The electrodes prepared in example 3 was put on one side of a Du Pont Nation 117 (7 mil thickness and 1100 equivalent weigh) membrane (from E. I. du Pont, Wilmington, Del., USA) as anode and an E-TEK standard DMFC cathode, which has 4.5 mg/cm² Pt, was put on the other side of the membrane. The assembly was pressed at 130° C. at a pressure about 50-100 atm for 3-5 min.

### Membrane Electrode Assembly (MEA) Testing

### Examples 7-10

MEAs prepared in Examples 4-6 were installed in triple serpentine graphite plate lab cell of 10 cm² active area. An activation procedure was then carried out as follows:
(1) Feed hot water ˜90° C. to the anode side and air (saturated at 80° C., ambient pressure) to the cathode side and maintain the cell at 80° C. Keep at this condition for about 1 hour.
(2) Catalyst activation. Feed H₂ to the anode and air to the cathode. Set H₂-humidifying bottle at 95° C., 15 psig, air-humidifying bottle at 80° C. (15-25 psig), and keep cell at 80° C. Allow cell to run at least 2-4 hours at 0.4-0.6 volts.

After the activation procedure, the hydrogen flow was stopped and purged completely with nitrogen. Then nitrogen flow was stopped and replaced with methanol, and the cells were slowly to cool down to 60° C. The MEA is subjected to a constant voltage operation at 0.2-0.3 volts for at least 30 min before the polarization curve was taken by stepwise changing cell volts at 50 mv increment.

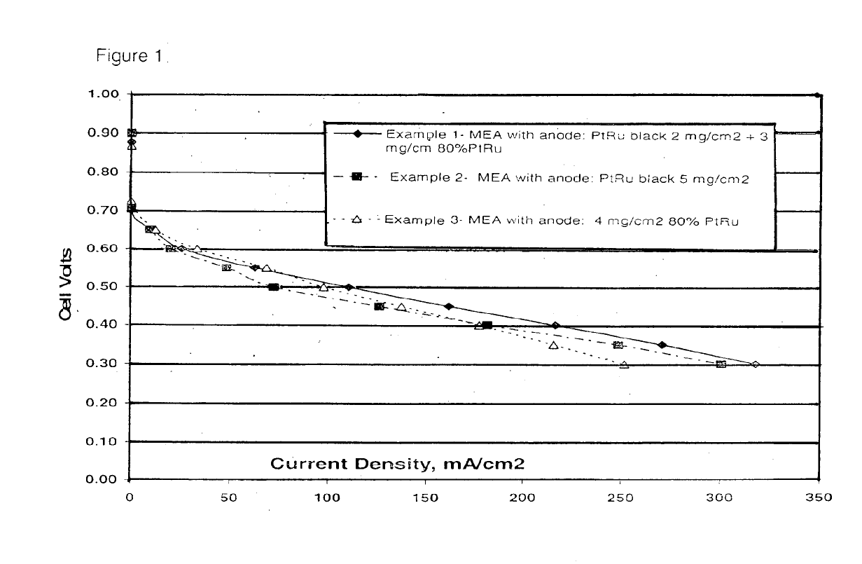

The polarization curves for the three MEAs made according to Example 1, Example 2 (Comparative), and Example 3 (Comparative) were shown in FIG. 1. As can be seen from FIG. 1, Example 1 with bi-layer 3 mg/cm² 80% PtRu and 2 mg/cm² PtRu black showed the best performance.

Example 2 with solely PtRu black showed inferior performance, especially at low current density because of higher cross-over of methanol caused by high percentage of very thin local areas in the PtRu black catalyst layer. Example 3 with solely 80% PtRu showed comparable performance to that of the Example 1 at low current density, but at high current density the thick electrode layer presents a barrier for methanol to diffuse; therefore, the performance even dropped below that of Example 2.

FIG. 1. Polarization Curves for DMFC MEAs with Anode of Examples 1 to 3 (Conditions: 60° C., Methanol Flow 5 mL/min, air flow 720 mL/min, air pressure 25 psig). Cathode has 4.5 mg/cm2 Pt black.

### Examples 11-12

### Anodes Preparation

Example 1 was repeated, but the PtRu black layer was applied as 1 mg/cm² or 3 mg/cm² respectively.

### Examples 13-14

### MEAs Preparation

MEA were prepared with the electrode in examples 11 or 12 as anode, respectively; and cathodes and membranes were as described in examples 4-6.

### Examples 15-16

### MEA Testing

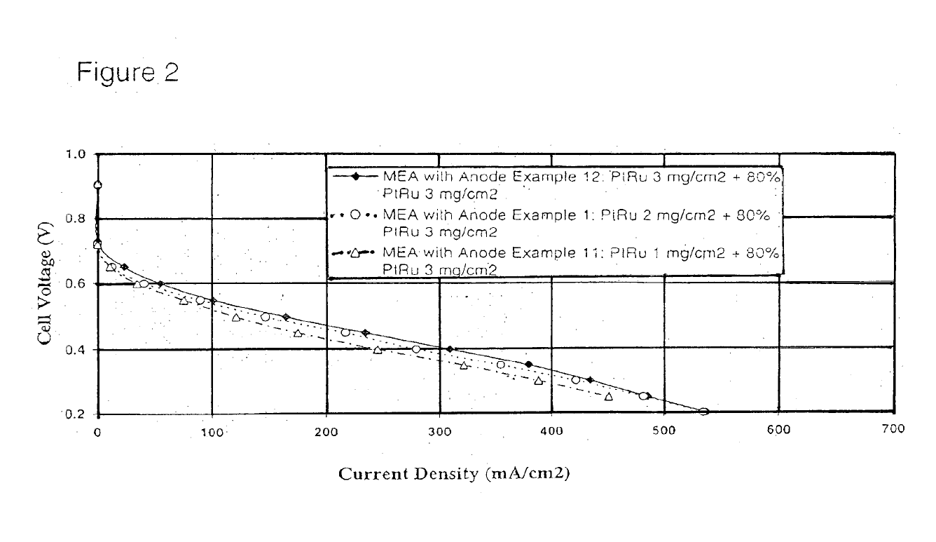

MEA prepared according to examples 13-14 were tested as described in examples 7-10. Their performances are compared to that of the MEA according to example 7. The results are as shown in FIG. 2.

FIG. 2. Polarization Curves for DMFC MEAs of Example 1, 11, and 12. (Conditions: 70° C., Methanol Flow 5 mL/min, air flow 720 mL/min, air pressure 25 psig)

As can be seen from FIG. 2, the performances are in the order Example 11>Example 1>Example 2. This is reasonable in view of the fact that the 80% PtRu loadings are the same for all three samples and the loadings of PtRu black are in the order Example 11>Example 1>Example 2. However, the performance of Example 11 is only slightly better than that of Example 1 which is significantly better than that of Example 12. It indicates that methanol can permeate through the 80% PtRu catalyst layer to reach PtRu black layer for higher total reaction rate. It also indicates that the combination of 80% PtRu and PtRu black bi-layer structure provides a good compromise between preventing cross-over and in the meantime provides sufficient catalyst utilization. If only 80% PtRu is used, at 6 mg/cm2 of PtRu one will inexperience very high methanol diffusion barrier; on the other hand, very high Pt black loading is needed to prevent cross-over caused by thin spots.

### Example 17

The GDM (prepared according to example 1) was applied with an ink prepared by mixing E-TEK 80% Pt on Ketjen Carbon Black (available from PEMEAS USA Inc. E-TEK® Division), which was synthesized as described in US Patent application (Appl. 20050227862), perfluorocarbon ion exchange ionomer, and an ethanol/water mixture as solvent is applied. The ink was applied with a film applicator to the GDL layer followed by drying at 70-95° C. Multiple layers are applied until a loading of 2 mg/cm² of total metal achieved. The next step is to apply an ink prepared by mixing Pt black catalyst (available from PEMEAS USA Inc. E-TEK® Division), perfluorocarbon ion exchange ionomer, and a surface active agent (Zonyl FSO® surfactant by E.I. du Pont). The ink was then applied on top of the 80% Pt/C catalyst layer to a total metal loading of 3 mg/cm2 of Pt black. Overall in this bi-layer anode, there were 5 mg/cm² total metal. After all layers were applied, a final drying at 70-95° C. for at least 30 min was conducted.

### Example 18

### Comparative Example

The GDM was applied with an ink prepared by mixing E-TEK 80% Pt on Ketjen Carbon Black (available from PEMEAS USA Inc. E-TEK® Division), which was synthesized as described in US Patent application (Appl. 20050227862), perfluorocarbon ion exchange ionomer, and an ethanol/water mixture as solvent is applied. The same drying process as in Example 1 was used. The total metal loading was 4 mg/cm².

### Membrane Electrode Assembly (MEA) Fabrication

### Examples 19 and 20

The electrodes prepared in examples 17 was put on one side of a du Pont Nafion 117 (7 mil thickness and 1100 equivalent weigh) membrane (from E. I. du Pont, Wilmington, Del., USA) as cathode and a DMFC anode, which has 80% PtRu (4 mg/cm²), was put on the other side of the membrane. The assembly was pressed at 130° C. at a pressure about 50-100 atm for 3-5 min. The same procedure was repeated for electrode prepared in example 18.

### MEA Testing

### Examples 21 and 22

MEAs prepared in examples 19 and 20 were installed in triple serpentine graphite plate lab cell of 10 cm² active area. An activation procedure as described in Example 7-10 was then carried out. After activation a polarization curve was taken for each sample.

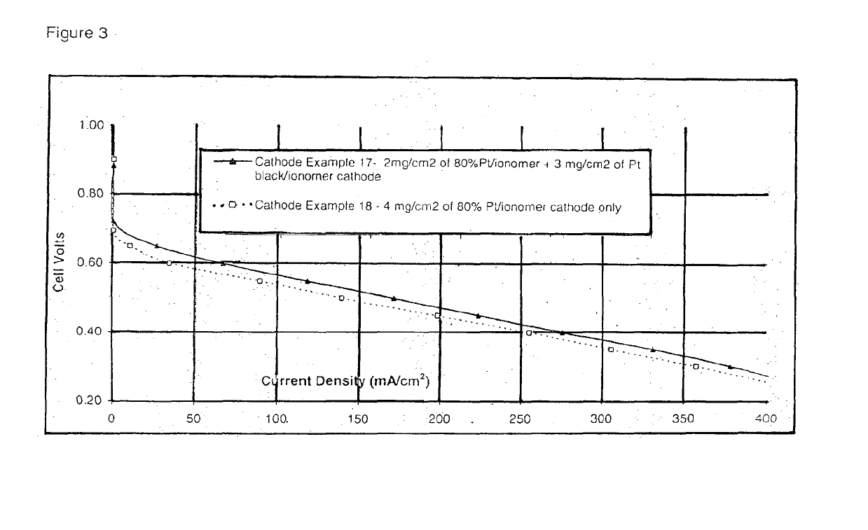

The polarization curves for the two MEAs made with electrode Example 17, Example 18 (Comparative) were shown in FIG. 3. The MEA with a cathode of example 17 (bi-layer 2 mg/cm², 80% Pt and 3 mg/cm² Pt black) showed better performance than that with a cathode of example 18 (solely 4 mg/cm², 80% Pt black catalyst. The performance difference can be understood by the high catalyst utilization of the bi-layer catalyst structure, which includes Pt black catalyst.

FIG. 3 Polarization Curves for DMFC MEAs with cathodes of example 17, and example 18.
The anode is 4 mg/cm² of total metal of 80% PtRu deposited on GDM.
Conditions: 80° C., Methanol Flow 5 mL/min, air flow 720 mL/min, air pressure 25 psig

The anode is 4 mg/cm² of total metal of 80% PtRu deposited on GDM.
Conditions: 80° C., Methanol Flow 5 mL/min, air flow 720 mL/min, air pressure 25 psig

### Example 23

The GDM was applied with an ink prepared by mixing Pt black catalyst (available from PEMEAS USA Inc. E-TEK® Division), perfluorocarbon ion exchange ionomer, and a surface active agent (Zonyl FSO® surfactant by EL du Pont). The same drying process as in Example 17 was used. The total metal loading was 4.5 mg/cm².

### Membrane Electrode Assembly (MEA) Fabrication

### Example 24

The procedure for making MEA (N117) as described for examples 19 and 20 was repeated with the electrode of example 17 as cathode and an anode with a bi-layer structure (3 mg/cm² of total metal with 80% PtRu on Ketjen Carbon Black first then followed by 3 mg/cm² of total metal with PtRu black).

### Example 25

Example 24 was repeated except the example 23 was used as cathode.

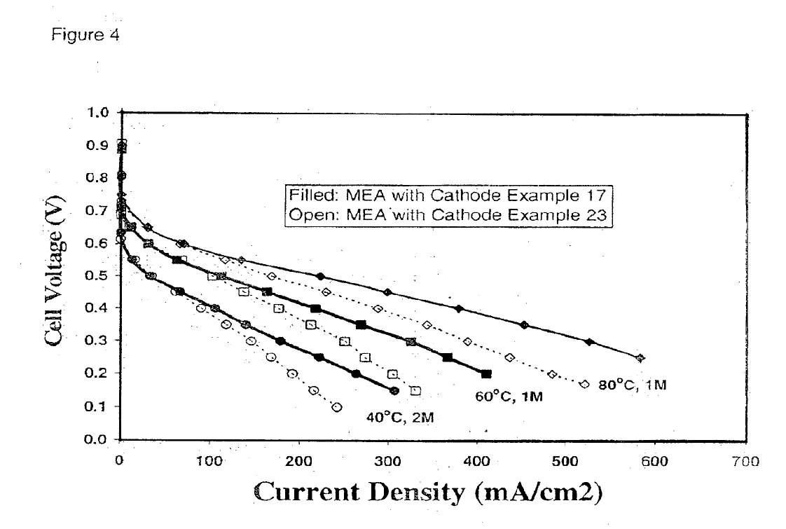

Examples 26 and 27 [former Examples 10-11, MEA Testing]
The testing of MEAs in Examples 24 and 25 followed that described for Examples 21 and 22 (MEA Testing). The polarizations curves are shown in FIG. 4 for 40° C., 60° C. and 80° C.

FIG. 4
Polarization Curves for DMFC MEAs with cathodes of Example 17, and Control Example 23. The anode has a bi-layer structure with 3 mg/cm² of 80% PtRu on Ketjen Carbon Black and 3 mg/cm² PtRu black
(Conditions: Methanol Flow 5 mL/in, air flow 720 mL/min, air pressure 25 psig, 40-80° C. cell temperature)

As can be seen from FIG. 4, the cathode with bi-layer structure (Example 17) showed better performance than the one with only Pt black catalyst (Example 23). The comparison indicates that the bi-layer, Pt black on 80% Pt has the optimized property for catalyst utilization and regulating water accumulation in cathode structure.

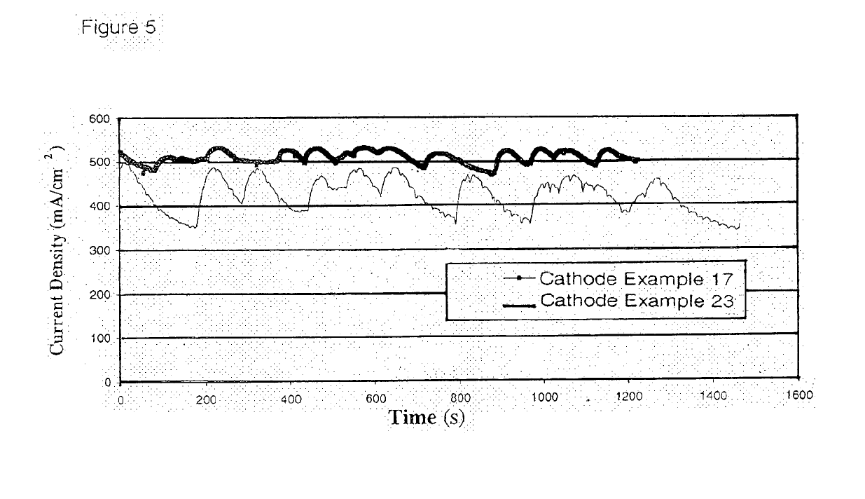

In addition to better performance the MEA with Example 17 (bi-layer structure) as cathode also shows very good performance stability with less current fluctuation than the MEA with Example 23 (solely with Pt black) as cathode. FIG. 5 illustrates the difference in current fluctuation for the two MEAs. This indicates the superior property of Example 17 cathode in regulating water for optimized oxygen diffusion/proton transport.

FIG. 5. Current Fluctuation of DMFC MEAs with cathodes of example 17 and example 23. The anode has a bi-layer structure with 3 mg/cm² of 80% PtRu on Ketjen Carbon Black and 3 mg/cm² PtRu black.
(Conditions: Methanol Flow 5 mL/min, air flow 720 mL/min, air pressure 25 psig, 80° C. cell temperature)

The anode has a bi-layer structure with 3 mg/cm² of 80% PtRu on Ketjen Carbon Black and 3 mg/cm² PtRu black.
(Conditions: Methanol Flow 5 mL/min, air flow 720 mL/min, air pressure 25 psig, 80° C. cell temperature)

1-23. (canceled)

24. A gas diffusion electrode comprising:
at least one gas diffusion media;
at least one supported catalyst layer disposed on top of the gas diffusion media, the supported catalyst layer comprising at least one supported catalyst; and
an unsupported catalyst layer disposed on top of the supported catalyst layer, the unsupported catalyst layer having a higher total catalyst loading than the supported catalyst layer.

25. The gas diffusion electrode of claim 24, wherein the gas diffusion media is electron conductive.

26. The gas diffusion electrode of claim 24, wherein the gas diffusion media comprises at least one of carbon fibre papers, graphitised carbon fibre papers, carbon fibre fabric, graphitised carbon fibre fabric, and sheets rendered conductive by the addition of carbon black.

27. The gas diffusion electrode of claim 24, the at least one gas diffusion media comprising two to three gas diffusion media.

28. The gas diffusion electrode of claim 24, wherein at least one of the supported or unsupported catalyst layers comprises platinum, palladium, rhodium, iridium, osmium and ruthenium.

29. The gas diffusion electrode of claim 24, wherein at least one of the supported or unsupported catalyst layers comprises alloys of platinum, palladium, rhodium, iridium, osmium and ruthenium with one or more non-precious metal.

30. The gas diffusion electrode of claim 30, the non-precious metal being selected from the group of Fe, Cr, Zr, Ni, Co, Mn, V and Ti.

31. The gas diffusion electrode of claim 30, wherein a metal content of the supported catalyst layer is in the range of about 10% to 90% by weight.

32. The gas diffusion electrode of claim 24, wherein the catalyst layers have a an overall thickness in the range of about 1 to 1000 μm.

33. The gas diffusion electrode of claim 24, wherein at least one of the catalyst layers includes an overall precious metal content of about 0.1 to 10.0 mg/cm².

34. The gas diffusion electrode of claim 24, wherein at least one of the catalyst layers faces an ion exchange membrane, the ion exchange membrane including at least one catalyst comprising carbon, carbon black, graphite or graphitized carbon black as support.

35. The gas diffusion electrode of claim 24, with at least two catalyst layers are disposed on top of the gas diffusion media, wherein each layer comprises at least one supported catalyst, the supported catalyst in each respective catalyst layer having a different metal content.

36. The gas diffusion electrode of claim 36, wherein a first of the supported catalyst layers has a lower metal content than a second of the supported catalyst layers towards the membrane, and the second supported catalyst layer faces an ion exchange membrane.

37. The gas diffusion electrode of claim 36, wherein the supported catalyst comprises at least one of Au and Ag.

38. The gas diffusion electrode of claim 36, wherein the supported catalyst is an alloy comprising (i) Pt, Pd, Ir, Rh, Os or Ru and (ii) Fe, Co, Ni, Cr, Mn, Zr, Ti, Ga or V.

39. The gas diffusion electrode of claim 24, wherein the supported catalyst comprises at least one of Pt, Pd, Ir, Rh, Os and Ru metals as catalyst.

40. The gas diffusion electrode of claim 24, wherein the unsupported catalyst comprises black precious metal catalysts.

41. The gas diffusion electrode of claim 41, wherein the black precious metal catalysts are at least one of Pt, Pd, Ir, Rh, Os and Ru.

42. The gas diffusion electrode of claim 41, wherein the black precious metal catalysts are alloys comprising (i) Pt, Pd, Ir, Rh, Os or Ru and (ii) Fe, Co, Ni, Cr, Mn, Zr, Ti, Ga or V.

43. The gas diffusion electrode of claim 41, wherein the black precious metal catalysts are Pt or PtRu metal catalysts.

44. The gas diffusion electrode of claim 24, wherein the supported catalyst layer comprises at least one supported catalyst having up to 80% by weight of Pt on a carbon support.

45. The gas diffusion electrode of claim 45, wherein the unsupported catalyst layer is Pt black or a PtRu black.

46. The gas diffusion electrode of claim 24, wherein the supported catalyst layer has a metal content of from about 10% to 95% Pt by weight

47. The gas diffusion electrode of claim 24, wherein the supported catalyst layer has a metal content of from about 20 to 90% Pt by weight.

48. The gas diffusion electrode of claim 24, wherein the supported catalyst layer has a metal content of from about 60 to 80% Pt by weight.

49. A membrane electrode unit comprising:
at least one ion exchange membrane; and
at least one gas diffusion electrode comprising:
at least one gas diffusion media;
at least one supported catalyst layer disposed on top of the gas diffusion media, the supported catalyst layer comprising at least one supported catalyst; and
an unsupported catalyst layer disposed on top of the supported catalyst layer, the unsupported catalyst layer having a higher total catalyst loading than the supported catalyst layer.

50. Them membrane electrode unit of claim 50, wherein the ion exchange membrane comprises a proton conductive membrane.
